(19) United States
(12) Patent Application Publication
(10) Pub. No.: US 2018/0014297 A1
(43) Pub. Date: Jan. 11, 2018

(54) METHOD FOR OPERATING WIRELESS LAN SYSTEM AND DEVICE FOR SAME

(71) Applicant: Samsung Electronics Co., Ltd., Gyeonggi-do (KR)

(72) Inventors: Hyun-Jeong Kang, Seoul (KR); Byoung-Hoon Jung, Seoul (KR); Sang-Hyun Chang, Seoul (KR)

(21) Appl. No.: 15/539,645

(22) PCT Filed: Dec. 24, 2015
(86) PCT No.: PCT/KR2015/014246

§ 371 Date: Jun. 23, 2017

(30) Foreign Application Priority Data
Dec. 24, 2014 (KR) 10-2014-0187766

(51) Int. Cl. H04W 72/04; H04W 24/08; H04W 72/08; H04W 28/18; H04W 88/08; H04W 84/12

(52) U.S. Cl. CPC H04W 72/0446; H04W 72/085; H04W 28/18; H04W 24/08; H04W 84/12; H04W 88/08

(57) ABSTRACT

The present disclosure relates to a pre-5th-Generation (5G) or 5G communication system to be provided for supporting higher data rates Beyond 4th-Generation (4G) communication system such as Long Term Evolution (LTE). The present invention provides a communication method in a wireless communication system. The method according to the present invention comprises the steps of: receiving, from a base station serving the station in a cellular network, information indicating a first transmission period of an access point serving the station in a wireless network; setting a first channel period, for communicating with the access point, based on the first transmission period, receiving, from the access point, information indicating a second transmission period determined by the access point; and updating the first channel period to a second channel period based on the second transmission period.

### CROSS-REFERENCE TO RELATED APPLICATION(S) AND CLAIM OF PRIORITY

This application is a National Phase Entry of PCT International Application No. PCT/KR2015/014246, which was filed on Dec. 24, 2015, and claims priority to Korean Patent Application No. 10-2014-0187766, which was filed in the Korean Intellectual Property Office on Dec. 24, 2014, the entire content of each of which is incorporated by reference.

### TECHNICAL FIELD

The present invention relates to a method and apparatus for operating resources in a wireless local area network (WLAN) system.

### BACKGROUND

To meet the demand for wireless data traffic having increased since deployment of 4G (4th-Generation) communication systems, efforts have been made to develop an improved 5G (5th-Generation) or pre-5G communication system. Therefore, the 5G or pre-5G communication system is also called a ‘beyond 4G network’ or a ‘post LTE system’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

Meanwhile, a communication system has been developed to support a high data transmission rate to satisfy continuously increasing wireless data traffic demands. For example, to increase a data transmission rate, the communication system has been developed to improve spectral efficiency based on various schemes, such as an Orthogonal Frequency Division Multiplexing (OFDM) scheme, a Multiple Input Multiple Output (MIMO) scheme, and the like, and to increase a channel capacity.

As an example, to support a high-capacity data service, the use of a Multiple User-Multiple Input Multiple Output (MU-MIMO) scheme, in which multiple users and multiple antennas are used together, and an Orthogonal Frequency Division Multiple Access (OFDMA) scheme, in which multiple channels are used at the same time, in the WLAN system is being considered.

The medium access control (MAC) protocol, which is based on the Institute of Electrical and Electronics Engineers (IEEE) 802.11 and operates based on a contention-based scheme, may regard two or more signal transmissions as colliding when two or more signals are simultaneously transmitted at a predetermined point in time. However, in an MIMO environment that uses multiple antennas, two or more signal transmissions may be detected at the same time. Therefore, the MU-MIMO scheme, which transmits signals using multiple antennas to users, may be supported. Also, in a multi-channel environment that uses multiple channels at the same time, two or more signal transmissions may be detected using different channels. Therefore, the OFDMA scheme, which transmits signals using multiple channels to multiple users, may be supported. Therefore, IEEE performs standardization to support the MU-MIMO and OFDMA schemes in the physical (PHY) layer and the MAC layer.

Also, in cellular-based communication services, the demand for high-capacity data continuously increases. However, the amount of resources to support a cellular service is limited and communication service fees are expensive, and thus a WLAN system is frequently utilized as an auxiliary system of the cellular system. A wireless LAN AP is installed around a cellular base station and a service that offloads data, which needs to be processed by the cellular base station, onto the wireless LAN AP is universalized. Requests for intimate control and processing between a cellular base station and a wireless LAN AP have gradually increased.

Hereinafter, the structure of a general WLAN system will be described with reference to FIG. 1.

FIG. 1 is a diagram schematically illustrating the structure of a general WLAN system.

Referring to FIG. 1, the WLAN system includes an access point (AP) 111 and a plurality of stations (STAs), for example, 5 STAs, namely STA#1 113, STA#2 115, STA#3 117, STA#4 119, and STA#5 121.

STA#1 113, STA#2 115, STA#3 117, STA#4 119, STA#5 121, and the AP 111 always monitor a channel and receive a corresponding signal. Also, in the case in which signal transmission is required, each of STA#1 113, STA#2 115, STA#3 117, STA#4 119, STA#5 121, and the AP 111 transmits a corresponding signal when the number of slots of which the channel state is the idle state is greater than or equal to a predetermined number of slots, which is a threshold value.

### SUMMARY

In a WLAN system, an uplink and a downlink may be embodied according to a contention-based scheme. Therefore, when a collision occurs between an uplink and a downlink, each of STA#1 113, STA#2 115, STA#3 117, STA#4 119, STA#5 121 and the AP 111 may perform a backoff operation of waiting until the number of slots of which the channel state is the idle state is greater than or equal to the predetermined number of slots corresponding to the threshold value, and transmits a corresponding signal again.

Therefore, an aspect of the present invention is to provide a method and apparatus for effectively managing a wireless LAN resource by utilizing a cellular base station in a WLAN system.

Also, another aspect of the present invention is to provide a method and apparatus for managing a wireless LAN transmission opportunity period by utilizing a cellular base station in a WLAN system.

Also, another aspect of the present invention is to provide a method and apparatus for managing the coexistence of a legacy wireless LAN device and a new wireless LAN device by utilizing a cellular base station in a WLAN system.

In accordance with an aspect of the present invention, there is provided a communication method of a station in a wireless communication system, the method comprising: receiving, from a base station serving the station in a cellular network, information indicating a first transmission period of an access point serving the station in a wireless network; setting a first channel period, for communicating with the access point, based on the first transmission period, receiving, from the access point, information indicating a second transmission period determined by the access point; and updating the first channel period to a second channel period based on the second transmission period.

In accordance with an aspect of the present invention, there is provided a communication method of an access point in a wireless communication system, the method comprising: determining, by the access point serving a station in a cellular network, information indicating a second transmission period for the access point, the information indicating the second transmission period being provided to the station by a base station serving the station in a wireless network; receiving, from the base station, information indicating a first transmission period of the access point; transmitting, to the station, the information indicating the second transmission period, the second transmission period shorter than the first transmission period; and communicating with the station during a channel period, the channel period being set based on the information indicating the second transmission period by the station.

In accordance with an aspect of the present invention, there is provided a station in a wireless communication system, the station comprising: a transceiver configured to communicate with an access point serving the station; and a controller configured to: receive, from a base station serving the station in a cellular network, information indicating a first transmission period of an access point serving the station in a wireless network; set a first channel period, for communicating with the access point, based on the first transmission period, receive, from the access point, information indicating a second transmission period determined the access point; and update the first channel period to a second channel period based on the second transmission period.

In accordance with an aspect of the present invention, there is provided an access point in a wireless communication system, the access point comprising: a transceiver configured to communicate with a station; and a controller configured to: determine information indicating a second transmission period for the access point, the information indicating the second transmission period being provided to the station by a base station serving the station in a wireless network; receive, from the base station, information indicating a first transmission period of the access point; transmit, to the station, the information indicating the second transmission period, the second transmission period shorter than the first transmission period; and communicate with the station during a channel period, the channel period being set based on the information indicating the second transmission period by the station.

According to an embodiment of the present invention, wireless LAN resources can be operated by utilizing a cellular base station in a WLAN system.

Also, according to an embodiment of the present invention, resources can be operated to enable radio resource efficiency to be increased by utilizing a cellular base station in a WLAN system.

Also, according to an embodiment of the present invention, radio resources can be optimally allocated in real time without a delay and a network can be operated by utilizing a cellular base station in a WLAN system.

### BRIEF DESCRIPTION OF THE DRAWINGS

FIG. 1 is a diagram schematically illustrating the structure of a general WLAN system;

FIG. 2 is a diagram schematically illustrating an operation scenario of a WLAN system that utilizes a cellular base station according to an embodiment of the present invention;

FIG. 3 is a diagram schematically illustrating an example of a signal flow that operates and manages a transmission opportunity period by utilizing a cellular base station in a WLAN system according to an embodiment of the present invention;

FIG. 4 is a diagram schematically illustrating an example of a signal flow that operates and manages a transmission opportunity period by utilizing a cellular base station in a WLAN system according to another embodiment of the present invention;

FIG. 5 is a diagram schematically illustrating a scenario for managing the existence of a legacy device and a new device by utilizing a cellular base station in a WLAN system according to an embodiment of the present invention;

FIG. 6 is a diagram schematically illustrating an example of signal flow for managing the existence of a legacy device and a new device by utilizing a cellular base station in a WLAN system according to an embodiment of the present invention;

FIG. 7 is a diagram schematically illustrating an example of signal flow for managing the existence of a legacy device and a new device by utilizing a cellular base station in a WLAN system according to another embodiment of the present invention;

FIG. 8 is a diagram schematically illustrating an example of signal flow for managing the existence of a legacy device and a new device by utilizing a cellular base station in a WLAN system according to another embodiment of the present invention;

FIG. 9 is a diagram schematically illustrating an internal structure of an AP that manages wireless LAN resources by utilizing a cellular base station in a WLAN system according to an embodiment of the present invention;

FIG. 10 is a diagram schematically illustrating an internal structure of an STA that manages wireless LAN resources by utilizing a cellular base station in a WLAN system according to an embodiment of the present invention; and

FIG. 11 is a diagram schematically illustrating an internal structure of an eNB that manages wireless LAN resources by utilizing a cellular base station in a WLAN system according to an embodiment of the present invention.

### DETAILED DESCRIPTION

Hereinafter, embodiments of the present invention will be described in detail with reference to the accompanying drawings. In the following description, it should be noted that only portions required for comprehension of operations according to the embodiments of the present invention will be described and descriptions of other portions will be omitted not to make subject matters of the present invention obscure. Meanwhile, terms described later are defined in consideration of the functions of the present invention, but the meaning of the terms may be changed according to a user, intention of an operator, or convention. Therefore, the definitions of the terms should be made based on the contents throughout the specification.

The present invention may have various modifications and various embodiments, among which specific embodiments will now be described more fully with reference to the accompanying drawings. However, it should be understood that the present invention is not limited to the specific embodiments, but the present invention includes all modifications, equivalents, and alternatives within the spirit and the scope of the present invention.

Although the terms including an ordinal number such as first, second, etc. can be used for describing various elements, the structural elements are not restricted by the terms. The terms are used merely for the purpose to distinguish an element from the other elements. For example, a first element could be termed a second element, and similarly, a second element could be also termed a first element without departing from the scope of the present invention. As used herein, the term “and/or” includes any and all combinations of one or more associated items.

The terms used herein are used only to describe particular embodiments, and are not intended to limit the present invention. As used herein, the singular forms are intended to include the plural forms as well, unless the context clearly indicates otherwise. In the present invention, the terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein, including technical and scientific terms, have the same meaning as those commonly understood by a person of ordinary skill in the art to which the present invention pertains. Such terms as those defined in a generally used dictionary are to be interpreted to have the meanings equal to the contextual meanings in the relevant field of art, and are not to be interpreted to have ideal or excessively formal meanings unless clearly defined in the present specification.

According to various embodiments of the present invention, an electronic device may include a communication functionality. The terminal may, for example, be a smart phone, a tablet personal computer (PC), a mobile phone, a video phone, an e-book reader, a desktop PC, a laptop PC, a netbook PC, a personal digital assistant (PDA), a portable multimedia player (PMP), an MP3 player, a mobile medical device, a camera, or a wearable device (e.g., head-mounted device (HMD), electronic clothes, an electronic bracelet, an electronic necklace, an electronic appcessory, an electronic tattoo, or a smart watch).

According to various embodiments of the present invention, the electronic device may be a smart home appliance with a communication functionality. The smart home appliance may, for example, be a television, a digital video disk (DVD) player, an audio player, a refrigerator, an air conditioner, a vacuum cleaner, an oven, a microwave, a washer, a drier, an air purifier, a set-top box, a TV box (e.g., Samsung HomeSync™, Apple TV™, or Google TV™), a gaming console, an electronic dictionary, a camcorder, or an electronic photo frame.

According to various embodiments of the present invention, the terminal may be a medical appliance (e.g., magnetic resonance angiography (MRA) device, magnetic resonance imaging (MRI) device, computed tomography (CT) device, and ultrasonic device), a navigation device, a global positioning system (GPS) receiver, an event data recorder (EDR), a flight data recorder (FDR), an automotive infotainment device, a marine electronic device (e.g., ship navigation device and a gyrocompass), avionics, security equipment, or an industrial or home robot.

According to various embodiments of the present invention, the electronic device may be a part of furniture or a building/structure, an electronic board, an electronic signature receiving device, a projector, and various kinds of measuring instruments (e.g., water meter, electric meter, gas meter, and electromagnetic wave meter), each of which has a communication functionality.

According to various embodiments of the present invention, the electronic device may be a combination of the above-mentioned devices. Further, it will be apparent to those skilled in the art that the terminal according to various embodiments of the present invention is not limited to the above-mentioned devices.

According to various embodiments of the present invention, a station (hereinafter referred to as a ‘STA’) may be, for example, an electronic device.

Also, according to various embodiments of the present invention, as an example, a STA may operate as a signal transmission device and a signal reception device. As an example, an access point (AP) may operate as a signal transmission device and a signal reception device. Also, according to various embodiments of the present invention, as an example, an AP may operate as a resource-operating device.

Also, according to various embodiments of the present invention, a cellular base station (i.e. enhanced node B (eNB)) may operate as a signal transmission device and a signal reception device. Also, according to various embodiments of the present invention, as an example, an eNB may operate as a resource-operating device of a wireless LAN system and a cellular system, and may operate as a device that manages the AP.

Meanwhile, a method and an apparatus proposed by an embodiment of the present invention can be applied to various communication systems, such as an Institute of Electrical and Electronics Engineers (IEEE) 802.11 communication system, an IEEE 802.16 communication system, a digital video broadcasting system such as a Digital Multimedia Broadcasting (DMB) service, a mobile broadcasting service such as a Digital Video Broadcasting-Handheld (DVP-H) and a mobile/portable Advanced Television Systems Committee Mobile/Handheld (ATSC-M/H) service, and an Internet Protocol Television (IPTV) service, a Moving Picture Experts Group (MPEG) Media Transport (MMT) system, an Evolved Packet System (EPS), a Long-Term Evolution (LTE) mobile communication system, an LTE-Advanced (LTE-A) mobile communication system, a High Speed Downlink Packet Access (HSDPA) mobile communication system, a High Speed Uplink Packet Access (HSUPA) mobile communication system, a High Rate Packet Data (HRPD) mobile communication system of 3rd Generation Project Partnership 2 (3GPP2), a Wideband Code Division Multiple Access (WCDMA) mobile communication system of 3GPP2, a Code Division Multiple Access (CDMA) mobile communication system of 3GPP2, and a Mobile Internet Protocol (Mobile IP) system.

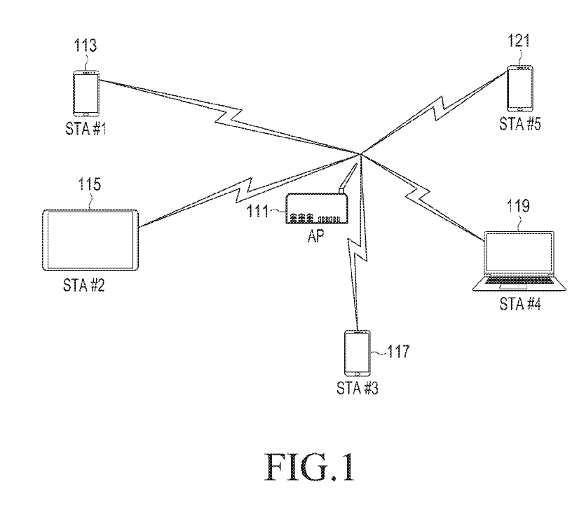

It is assumed that the WLAN system supported by the present invention has the same structure as that of the WLAN system which has been described with reference to FIG. 1.

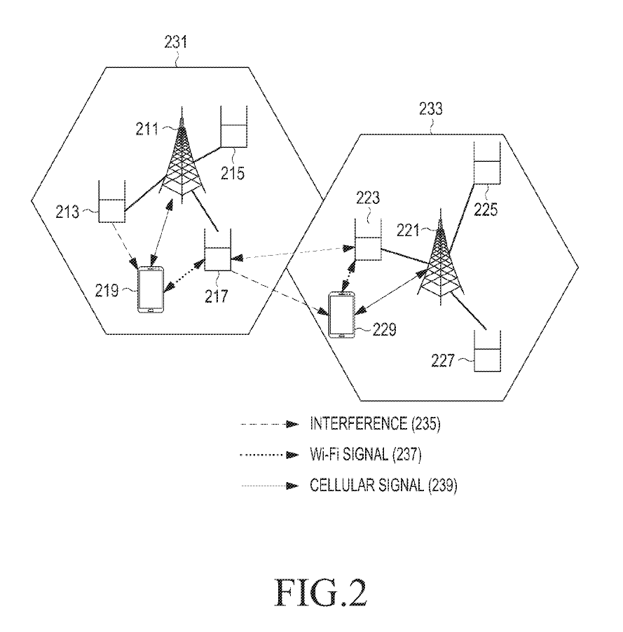

An operation scenario of a WLAN system that utilizes a cellular base station according to an embodiment of the present invention will be described with reference to FIG. 2.

FIG. 2 is a diagram schematically illustrating an operation scenario of a WLAN system that utilizes a cellular base station according to an embodiment of the present invention.

Referring to FIG. 2, a cell 231 managed by an eNB 211 includes an AP 213, an AP 215, an AP 217, and an STA 219. A cell 233 managed by an eNB 221 includes an AP 223, an AP 225, an AP 227, and an STA 229. The eNB 211 is a serving eNB of the STA 219, and the AP 217 is a serving AP of the STA 219. The AP 213 is a neighbor AP that interferes with the STA 219. The eNB 221 is a serving eNB of the STA 229, and the AP 223 is a serving AP of the STA 229. The AP 217 is a neighbor AP that interferes with the STA 229. The AP 217 and the AP 223 may detect each other's signals. Also, although not illustrated in FIG. 2, the eNB 211 and the eNB 221 may be connected through a wireless or wired interface.

An eNB may play a part in the operation of the wireless LAN of an STA and APs that the eNB manages. For example, to operate a wireless LAN transmission opportunity period without interference between neighboring APs, there is a desire for a scheme of enabling an AP to monitor a wireless LAN transmission opportunity period of each AP. However, the scheme in which the AP obtains wireless LAN transmission opportunity period information of a neighbor AP from an STA, which is connected to the AP and performs communication, in order to monitor the wireless LAN transmission opportunity period, may cause overhead of the STA. Also, it is not permissible for an STA to obtain wireless LAN transmission opportunity period information with respect to an AP that is not shown to the STA (a hidden AP). Therefore, there is a desire for a scheme of obtaining wireless LAN transmission opportunity period information using an eNB that has recognized the existence of an AP and a STA.

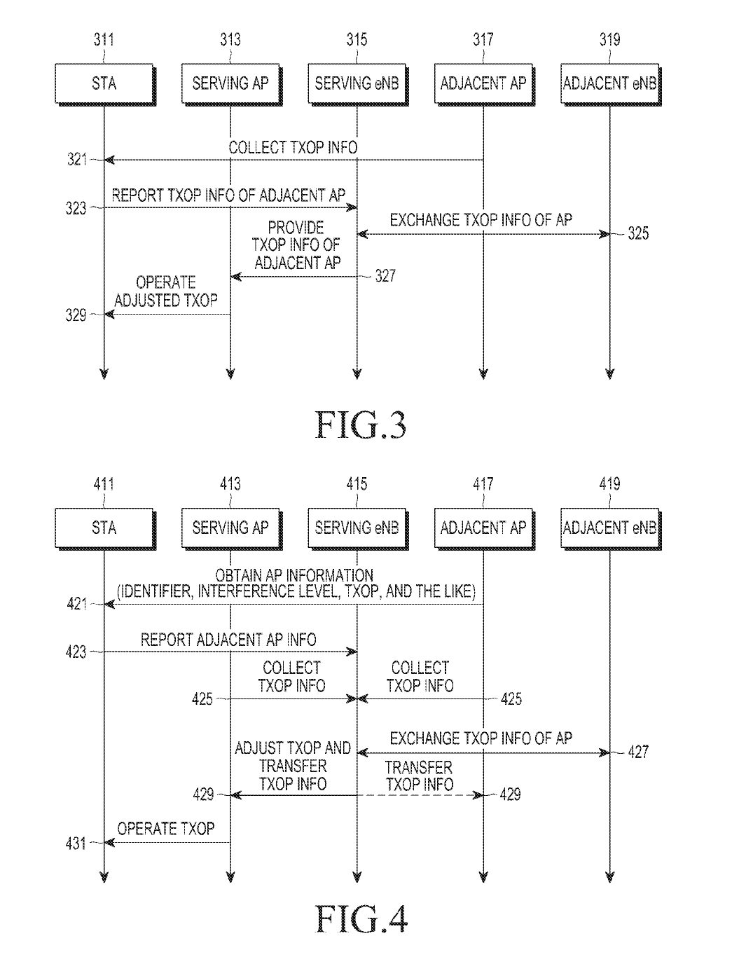

FIG. 3 is a diagram schematically illustrating an example of a signal flow that operates and manages a transmission opportunity period by utilizing a cellular base station in a WLAN system according to an embodiment of the present invention.

Referring to FIG. 3, an STA 311 obtains transmission opportunity period information (TXOP info) of a neighbor AP 317 that interferes with data transmission/reception executed with a serving AP 313 in operation 321. The transmission opportunity period information may be obtained from a frame (e.g., a beacon frame) transmitted by the neighbor AP 317. The STA 311 reports the obtained transmission opportunity period information of the neighbor AP 317 to a serving eNB 315 in operation 323. When the STA 311 is incapable of directly obtaining the transmission opportunity period information of the neighbor AP 317, the STA 311 reports an identifier of a neighbor AP that causes interference.

When the neighbor AP 317 that interferes with the STA 311 is an AP that is managed by a neighbor eNB 319, instead of the serving eNB 315, the serving eNB 315 may obtain the transmission opportunity period information of the neighbor AP 317 through signaling with the neighbor eNB 319. In this instance, the serving eNB 315 may provide the transmission opportunity period information of an AP managed by the serving eNB 315 to the neighbor eNB 319. The serving eNB 315 may transfer, to the serving AP 313, the obtained transmission opportunity period information associated with APs, including the neighbor AP 317, which interfere with the STA 311 in operation 327. The serving AP 313 adjusts the transmission opportunity period of the serving AP 313 by reflecting the transmission opportunity period information of the neighbor APs received from the serving eNB 315, and operates the same in operation 329.

The serving eNB 315 may obtain, from the serving AP 313, information associated with a neighbor AP that causes interference. That is, the serving AP 313 may provide the serving eNB 315 with information about the situation in association with a resource occupancy rate, a collision rate, a delay, and the like in a WLAN system that the serving AP 313 manages. The neighbor AP may correspond to a hidden AP of which a signal is not detected by the STA 311 or by the serving AP 313.

Time information associated with a transmission opportunity period of FIG. 3 may be expressed as a unit of time (e.g., a frame index or a superframe index) of a cellular system.

FIG. 4 is a diagram schematically illustrating an example of a signal flow that operates and manages a transmission opportunity period by utilizing a cellular base station in a WLAN system according to another embodiment of the present invention.

Referring to FIG. 4, an STA 411 collects information associated with a neighbor AP 417 that interferes with data transmission/reception performed with a serving AP 413 in operation 421. The neighbor AP information may include an identifier, an interference level, and transmission opportunity period information of the AP that causes interference. The transmission opportunity period information may be obtained from a frame (e.g., a beacon frame) transmitted by the neighbor AP 417 in operation 421. The STA 411 reports the obtained information associated with the neighbor AP 417 to a serving eNB 415 in operation 423. The serving eNB 415 collects the transmission opportunity period information associated with the serving AP 413 and the neighbor AP 417 that interferes with operation 425. When the neighbor AP 417 that interferes with the STA 411 is an AP that is managed by a neighbor eNB 419, the serving eNB 415 may obtain the transmission opportunity period information of the neighbor AP 417 through signaling with the neighbor eNB 419 in operation 427. In this instance, the serving eNB 415 may provide the transmission opportunity period information of an AP managed by the serving eNB 415 to the neighbor eNB 419. The serving eNB 415 adjusts the transmission opportunity periods of APs including the neighbor AP 417, which interferes with the STA 411, based on the obtained information associated with APs, and transfers the adjusted transmission opportunity period information to the serving AP 413 in operation 429. Also, the serving eNB 415 may transmit the adjusted transmission opportunity period information to the neighbor AP 417. The serving AP 413 operates its transmission opportunity period based on the transmission opportunity period information received from the serving eNB 415 in operation 431.

The serving eNB 415 may obtain, from the serving AP 413, information associated with a neighbor AP that causes interference. That is, the serving AP 413 may provide the serving eNB 415 with information about the situation in association with a resource occupancy rate, a collision rate, a delay, and the like in the WLAN system that the serving AP 413 manages. The neighbor AP may correspond to a hidden AP of which a signal is not detected by the STA 411 and the serving AP 413.

Time information associated with a transmission opportunity period of FIG. 4 may be expressed as a unit of time (e.g., a frame index or a superframe index) of a cellular system.

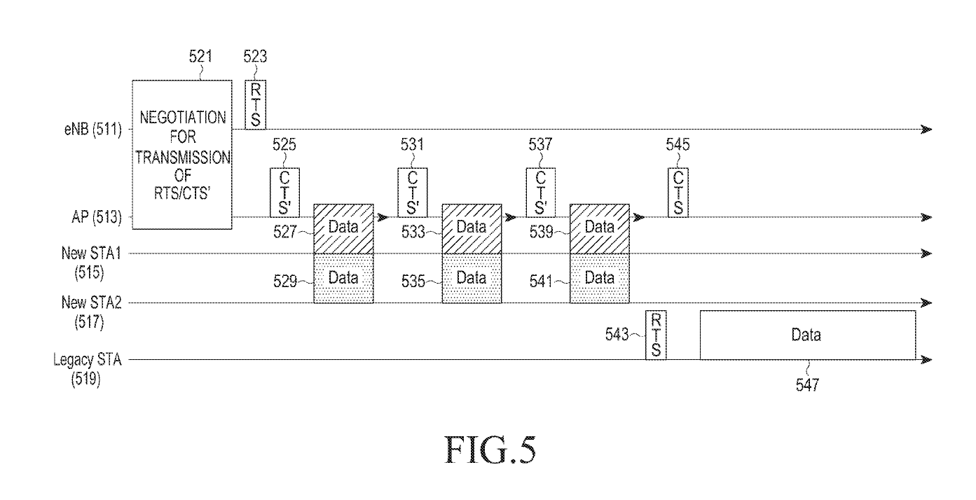

Subsequently, a method of providing service fairness to a legacy device (legacy STA) and a new device (new STA) by increasing system efficiency in a WLAN system where the legacy device and the new device coexist will be described with reference to FIG. 5.

In the WLAN system where the legacy device and the new device coexist, a system parameter or a communication scheme used by the legacy device may be ineffective to the new device, and thus the amount of service time of the new device may be decreased or a service for the new device may be delayed. For example, when the transmission scheme basically supported by the legacy device has a data transmission rate lower than the data transmission rate of the new device, the amount of service time of the legacy device is long, and thus service for the new device may be delayed. Accordingly, the benefit of a new system that supports a high data transmission rate may not be utilized, and the low system efficiency of the legacy system may be obtained.

Therefore, embodiments of the present invention propose a method of operating a Request to send/Clear to send (RTS-CTS) frame, which reserves a transmission opportunity period to prevent a legacy device from exclusively using a transmission opportunity period of a WLAN system. The RTS is used for a legacy device and a new device to determine transmission opportunity period information, and utilizes the same frame as a legacy frame. The CTS utilizes a new CTS frame which allows a new device to determine that a transmission opportunity period is different from a transmission opportunity period of the RTS, even though a legacy device is incapable of interpreting the same. In an embodiment of the present invention, the transmission opportunity period of an RTS frame is set to be longer than the transmission opportunity period of a new CTS frame. Therefore, a legacy device recognizes that a channel is reserved by another device during the transmission opportunity period of an RTS frame, and a new device recognizes that a channel is reserved by another device during the transmission opportunity period of a new CTS frame. Therefore, services may be efficiently provided to new devices during the transmission opportunity period of an RTS frame. Hereinafter, a new CTS frame is referred to as a CTS′ frame in embodiments of the present invention.

An AP changes a new RTS-CTS′ frame proposed in an embodiment of the present invention or a legacy RTS-CTS frame according to the ratio or proportion of legacy devices to new devices. That is, when the ratio or proportion of legacy devices is greater than or equal to a predetermined value, a legacy RTS-CTS frame is utilized. When the ratio or proportion of new devices is greater than or equal to a predetermined value, a new RTS-CTS′ frame is utilized.

FIG. 5 is a diagram schematically illustrating a scenario for managing a legacy device and a new device by utilizing a cellular base station in a WLAN system according to an embodiment of the present invention.

Referring to FIG. 5, an eNB 511 manages an AP 513, a new STA1 515, a new STA2 517, and a legacy STA 519. The AP 513 transmits and receives data to/from the new STA1 515, the new STA2 517, and the legacy STA 519. Each of the new STA1 515 and the new STA2 517 has a communication module that allows the transmission and reception of data to/from the eNB 511. The AP 513 determines whether to use a CTS′ frame based on the radio or proportion of new STAs and legacy STAs. When the AP 513 determines to use the CTS′ frame, the AP 513 requests the eNB 511 to use an RTS-CTS′ frame in operation 521. Negotiation for utilization of RTS-CTS′ frame transmission between the eNB 511 and the AP 513 may be performed using a wireless or wired interface. During the negotiation for the utilization of the RTS-CTS′ frame, the AP 513 may deliver, to the eNB 511, a transmission opportunity period value to be included in an RTS. As a result of the negotiation, the eNB 511 transmits an RTS frame in operation 523. Here, the eNB 511 is a device having a WLAN communication module. The AP 513 transmits a CTS′ frame as a response to the RTS frame transmitted by the eNB 511 in operation 525. It is preferable that a transmission opportunity period value included in the CTS′ frame be set to be smaller than the transmission opportunity period value included in the RTS. The AP 513 performs transmission/reception of data to/from the new STA1 515 or the new STA2 517 within the transmission opportunity period obtained through the RTS-CTS′ frame in operations 527 and 529. As described above, according to the embodiment of the present invention, after the transmission opportunity period indicated by the CTS′ frame is terminated, when the AP 513 desires to continue the transmission/reception of data to/from the new STA1 515 or the new STA2 517 or to transmit/receive data to/from another new STA, the AP 513 transmits a new CTS′ frame in operation 531. As described above, the transmission/reception of data to/from the new STA1 515 and the new STA2 517 are allowed at the same time thanks to the use of the CTS′ frame, and thus the effect of OFDMA transmission may be obtained. Subsequently, the AP 513 may transmit/receive data to/from the new STA1 515 or the new STA2 517, or to/from another new STA in a transmission opportunity period indicated by the CTS′ frame 531, in operations 533 and 535. The AP 513 may repeatedly perform operations 537 to 541 of transmitting a CTS′ frame and transmitting/receiving data within a given period (a transmission opportunity period secured from the RTS frame) to continue transmission/reception of data to/from the new STA1 515 or the new STA2 517, or to/from another new STA. When a WLAN channel enters an idle state after data transmission/reception between the AP 513 and a new STA is terminated, an opportunity to use a channel is given to the legacy STA 519, and the legacy STA 519 transmits an RTS frame to occupy a channel in operation 543, and receives a CTS frame from the AP 513 in operation 545. The legacy STA 519 and the AP 513 transmit and receive data within a transmission opportunity period obtained from the RTS 543 and the CTS 545 in operation 547.

Although FIG. 5 illustrates that the AP 513 determines to perform RTS-CTS′ frame exchange, the eNB 511 may determine the ratio or proportion of legacy devices and new devices in a WLAN system, determine to perform RTS-CTS′ frame exchange, and begin a negotiation procedure with the AP 513.

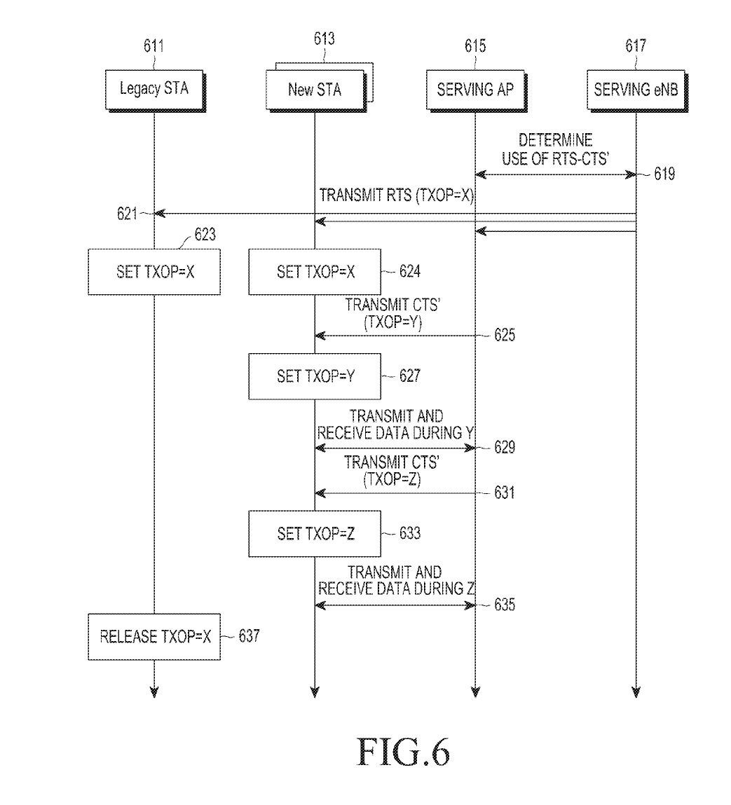

FIG. 6 is a diagram schematically illustrating an example of signal flow for managing the existence of existing legacy device and a new device by utilizing a cellular base station in a WLAN system according to an embodiment of the present invention.

Referring to FIG. 6, a serving AP 615 determines whether to use an RTS-CTS frame or an RTS-CTS′ frame based on the ratio or proportion of legacy STAs and new STAs that use a WLAN system. In this instance, when the ratio or proportion of legacy devices is greater than or equal to a predetermined value, a legacy RTS-CTS frame is utilized. When the ratio or proportion of new devices is greater than or equal to a predetermined value, a new RTS-CTS′ frame is utilized. When the AP 615 determines to use the RTS-CTS′ frame, the serving AP 615 informs a serving eNB 617 that the RTS-CTS′ frame is to be used in operation 619. The serving eNB 617 transmits an RTS frame to STAs based on the determination made by the serving AP 615 in operation 621. In this instance, the RTS frame is transmitted by setting a transmission opportunity period to X. The legacy STA 611 and the new STA 613 that receive the RTS frame set a channel occupancy period to X and monitor a channel during the corresponding period in operations 623 and 624. Subsequently, the serving AP 615 transmits a CTS′ frame in response to the RTS frame in operation 625. In this instance, the CTS′ frame is transmitted by setting a transmission opportunity period to Y. It is preferable that Y be set to a value smaller than X. The new STA 613 that receives the CTS′ frame resets the channel occupancy period to Y and monitors a channel during the corresponding period in operation 627. The CTS′ frame may be replaced with a transmission indication frame. In this instance, the transmission indication frame may include information associated with a new STA with which data transmission and reception is to be performed during the transmission opportunity period Y. The serving AP 615 transmits and receives data to/from the new STA 613 during the transmission opportunity period Y in operation 629. When the serving AP 615 desires to continue the transmission and reception of data to/from the new STA 613 even after the transmission opportunity period Y is terminated, the serving AP 615 transmits a new CTS′ frame in operation 631. In this instance, the transmission opportunity period of the newly transmitted CTS′ frame is set to Z. It is preferable that Z be set to a value less than or equal to Z. Also, it is preferable to exclude the amount of time corresponding to Y from X when setting Z. The new STA 613 that receives the second CTS′ frame sets a channel occupancy period to Z, and monitors a channel during the corresponding period in operation 633. The second CTS′ frame may be replaced with a transmission indication frame. In this instance, the transmission indication frame may include information associated with a new STA to/from which the data is to be transmitted/received during the transmission opportunity period Z. The serving AP 615 transmits and receives data to/from the new STA 613 during the transmission opportunity period Z in operation 635. When the serving AP 615 desires to continue the transmission and reception of data to/from the new STA 613 even after the transmission opportunity period Z is terminated, the serving AP 615 transmits a new CTS′ frame or a transmission indication frame again. When there is no need to service the new STA 613 any longer after the transmission opportunity period Z is terminated, the transmission of a CTS′ frame or a transmission indication frame is interrupted. In operation 637, the legacy STA 611 releases the transmission opportunity period X when the transmission opportunity period X is terminated or a channel maintains an idle state.

Although FIG. 6 illustrates that the AP 615 determines to perform RTS-CTS′ frame exchange, the eNB 617 may determine the ratio or proportion of legacy devices and new devices in a WLAN system, determine to perform RTS-CTS′ frame exchange, and begin a negotiation procedure with the AP 615.

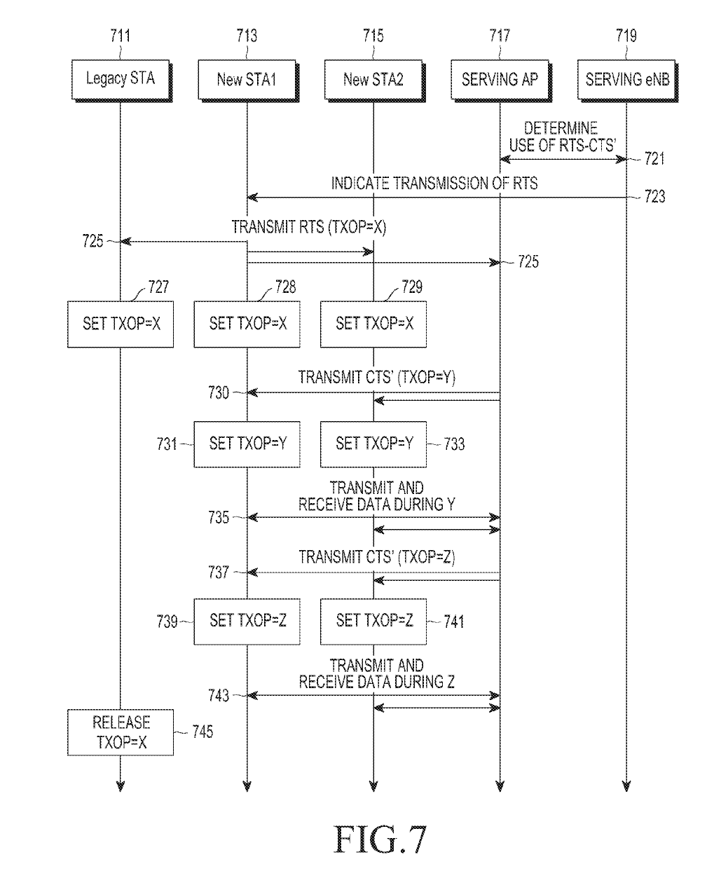

FIG. 7 is a diagram schematically illustrating an example of signal flow for managing the existence of a legacy device and a new device by utilizing a cellular base station in a WLAN system according to another embodiment of the present invention.

Referring to FIG. 7, a serving AP 717 determines whether to use an RTS-CTS frame or an RTS-CTS′ frame based on the ratio of legacy STAs and new STAs that use a WLAN system. In this instance, when the ratio or proportion of legacy devices is greater than or equal to a predetermined value, the serving AP 717 may determine to use a legacy RTS-CTS frame. When the ratio or proportion of new devices is greater than or equal to a predetermined value, the serving AP 717 may determine to use a new RTS-CTS′ frame. When the serving AP 717 determines to use the RTS-CTS′ frame, the serving AP 717 informs the serving eNB 719 that the RTS-CTS′ frame is to be used in operation 721. Also, the serving AP 717 selects a new STA, which is a target to which an RTS frame is to be transmitted, during the negotiation with the serving eNB 719. As the new STA to which the RTS frame is to be transmitted, an STA that has downlink data to be received, or uplink data to be transmitted, may be selected. In the example of FIG. 7, the new STA1 713 may be selected as a target STA to which the RTS frame is to be transmitted. The serving eNB 719 indicates the transmission of an RTS frame to the new STA1 713. The RTS frame transmission indication may be transmitted through a cellular communication link between the serving eNB 719 and the new STA1 713. Transmission opportunity period information is included in the RTS frame transmission indication. The new STA1 713 that receives the RTS frame transmission indication transmits an RTS frame in operation 725. The RTS frame includes transmission opportunity period information, and a transmission opportunity period value is set to the same value as that of the transmission opportunity period information included in the RTS frame transmission indication. A legacy STA 711 and a new STA2 715 that receive the RTS frame set a channel occupancy period to X, and monitor a channel during the corresponding period in operations 727 and 729. Also, the new STA1 713 that transmits the RTS frame sets a channel occupancy period to X and monitors a channel during the corresponding period in operation 728. Subsequently, the serving AP 717 transmits a CTS′ frame in response to the RTS frame in operation 730. A transmission opportunity period of the CTS′ frame is set to Y. It is preferable that Y be set to a value smaller than X. The CTS′ frame may be replaced with a transmission indication frame. The transmission indication frame may include information associated with a new STA, which is a target to/from which data is to be transmitted and received during the transmission opportunity period Y. The new STA 713 and the new STA2 715 that receive the CTS′ frame reset the channel occupancy period to Y, and monitor a channel during the corresponding period in operations 731 and 733. The serving AP 717 transmits/receives data to/from the new STA1 713 and the new STA2 715 during the transmission opportunity period Y in operation 735. When the serving AP 717 desires to continue the transmission and reception of data to/from the new STA1 713 and the new STA2 715 even after the transmission opportunity period Y is terminated, the serving AP 717 transmits a new CTS′ frame in operation 737. The transmission opportunity period of the new CTS′ frame is set to Z, and Z may be set to a value less than X by excluding the amount of time corresponding to Y from X. The new CTS′ frame may be replaced with a transmission indication frame. The transmission indication frame may include information associated with a new STA, which is a target to/from which data is to be transmitted and received during the transmission opportunity period Z.

The new STA1 713 and the new STA2 715 that receive the new CTS′ frame or the transmission indication frame set a channel occupancy period to Z, and monitor a channel in operations 739 and 741. The serving AP 717 transmits/receives data to/from the new STA1 713 and the new STA2 715 during the transmission opportunity period Z in operation 743. When the serving AP 717 desires to continue the transmission and reception of data to/from the new STA 713 and the new STA2 715 even after the transmission opportunity period Z is terminated, the serving AP 717 transmits a new CTS′ frame or a transmission indication frame. When there is no need to service the new STA1 713 and the new STA2 715 any longer after the transmission opportunity period Z is terminated, the serving AP 717 interrupts the transmission of the CTS′ frame or the transmission indication frame. In operation 745, the legacy STA 711 releases the transmission opportunity period X when the transmission opportunity period X is terminated or a channel maintains an idle state.

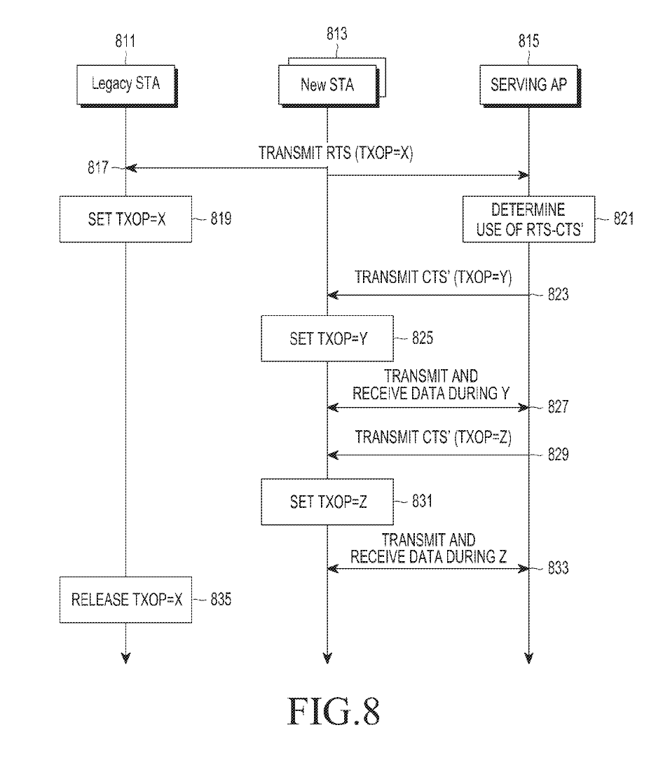

FIG. 8 is a diagram schematically illustrating an example of signal flow for managing the existence of a legacy device and a new device by utilizing a cellular base station in a WLAN system according to another embodiment of the present invention.

Referring to FIG. 8, a new STA 813 transmits an RTS frame to secure a transmission opportunity period in operation 817. The RTS frame includes a transmission opportunity period and sets the value thereof to X. A legacy STA 811 that receives the RTS frame sets a channel occupancy period to X and monitors a channel during the corresponding period in operation 819. The serving AP 815 that receives the RTS frame determines the transmission of one of a CTS frame and a CTS′ frame in response to the RTS frame in operation 821. The serving AP 815 determines whether to transmit the CTS frame or the CTS′ frame based on a ratio or proportion of legacy STAs and new STAs, which receive services in a WLAN network of the serving AP 815. In this instance, when a ratio or proportion of legacy devices is greater than or equal to a predetermined value, the AP 815 may determine to use a legacy RTS-CTS frame. When a ratio or proportion of new devices is greater than or equal to a predetermined value, the AP 815 may determine to use a new RTS-CTS′ frame. Information associated with the ratio or proportion of legacy STAs and new STAS may be information determined by the serving AP 815 or information received from a serving eNB that manages the serving AP 815.

Alternatively, the serving eNB may determine to use the CTS′ frame based on a ratio or proportion of legacy STAs and new STAs, and may indicate the use of the CTS′ frame to the serving AP 815.

When the serving AP 815 determines to use an RTS-CTS′ frame, the serving AP 815 transmits a CTS′ frame in response to the RTS frame in operation 823. The transmission opportunity period of the CTS′ frame is set to Y, and it is preferable that Y be set to a value smaller than X. The CTS′ frame may be replaced with a transmission indication frame. The transmission indication frame may include information associated with a new STA to which data is to be transmitted and received during the transmission opportunity period Y.

The new STA 813 that receives the CTS′ frame sets the channel occupancy period to Y and monitors a channel during the corresponding period in operation 825. The serving AP 815 transmits and receives data to/from the new STA 813 during the transmission opportunity period Y in operation 827. When the serving AP 815 desires to continue the transmission and reception of data to/from the new STA 813 even after the transmission opportunity period Y is terminated, the serving AP 815 transmits a new CTS′ frame in operation 829. The transmission opportunity period of the CTS′ frame is set to Z, and it is preferable that Z be set to a value less than X by excluding the amount of time corresponding to Y from X. The new CTS′ frame may be replaced with a transmission indication frame. The transmission indication frame may include information associated with a new STA to/from which the data is to be transmitted and received during the transmission opportunity period Z.

The new STA 813 that receives the new CTS′ frame sets the channel occupancy period to Z and monitors a channel during the corresponding period in operation 831. The serving AP 815 transmits and receives data to/from the new STA 813 during the transmission opportunity period Z in operation 833. When the serving AP 815 desires to continue the transmission and reception of data to/from the new STA 813 even after the transmission opportunity period Z is terminated, the serving AP 815 transmits a new CTS′ frame or a new transmission indication frame again. When there is no need to service the new STA 813 any longer after the transmission opportunity period Z is terminated, the serving AP 815 interrupts the transmission of a CTS′ frame or a transmission indication frame. The legacy STA 811 releases the transmission opportunity period X when X is terminated or when a channel remains in an idle state.

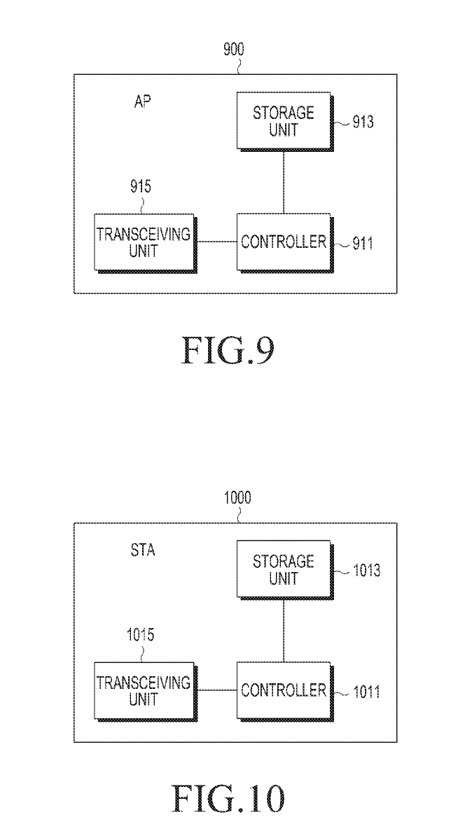

FIG. 9 is a diagram schematically illustrating an internal structure of an AP that manages wireless LAN resources by utilizing a cellular base station in a WLAN system according to an embodiment of the present invention.

Referring to FIG. 9, an AP 900 includes a controller 911, a storage 913, and a transceiver 915.

The controller 911 controls the general operation of the AP 900. The controller 911 controls the general operation of the AP 900, in association with operating a transmission opportunity period with assistance from a cellular base station according to an embodiment of the present invention, and operating a transmission opportunity period in an environment where a legacy device and a new device coexist with assistance from a cellular base station according to an embodiment of the present invention.

The transceiver 915 transmits and receives various signals and various messages to/from an STA, an eNB, and the like under the control of the controller 911. Here, the various signals and various messages that the transceiver 915 transmits and receives are the same as those of FIGS. 2 to 8, which have been described above, and thus a detailed description thereof will be omitted.

The storage 913 stores programs and various data required for the operation of the AP 900, particularly information related to operating a transmission opportunity period with assistance from a cellular base station according to an embodiment of the present invention or operating a transmission opportunity period in an environment where a legacy device and a new device coexist with assistance from a cellular base station according to an embodiment of the present invention. Also, the storage 913 stores various signals and various messages that the transceiver 915 receives from the STA, the eNB, and the like.

Although FIG. 9 illustrates that the AP 900 is configured as separate units, such as the transceiver 915, the controller 911, and the storage 913, it is also feasible that the AP 900 is configured in a manner in which at least two of the transceiver 915, the controller 911, and the storage 913 are integrated into a single unit.

FIG. 10 is a diagram schematically illustrating an internal structure of an STA that manages wireless LAN resources by utilizing a cellular base station in a WLAN system according to an embodiment of the present invention.

Referring to FIG. 10, an STA 1000 includes a controller 1011, a storage 1013, and a transceiver 1015.

The controller 1011 controls the general operation of the STA 1000. The controller 1011 controls the general operation of the STA 1000 in association with operating a transmission opportunity period with assistance from a cellular base station according to an embodiment of the present invention, and operating a transmission opportunity period in an environment where a legacy device and a new device coexist, with assistance from a cellular base station according to an embodiment of the present invention.

The transceiver 1015 transmits and receives various signals and various messages to/from an AP, an eNB, and the like under the control of the controller 1011. Here, the various signals and various messages that the transceiver 1015 transmits and receives are the same as those of FIGS. 2 to 8, which have been described, and thus a detailed description thereof will be omitted.

The storage 1013 stores programs and various data required for the operation of the STA 1000, particularly, information related to operating a transmission opportunity period with assistance from a cellular base station according to an embodiment of the present invention or operating a transmission opportunity period in an environment where a legacy device and a new device coexist, with assistance from a cellular base station according to an embodiment of the present invention. Also, the storage 1013 stores various signals and various messages that the transceiver 1015 receives from the AP, the eNB, and the like.

Although FIG. 10 illustrates that the STA 1000 is configured as separate units, such as the transceiver 1015, the controller 1011, and the storage 1013, it is also feasible that the STA 1000 is configured in a manner such that at least two of the transceiver 1015, the controller 1011, and the storage 1013 are integrated as a single unit.

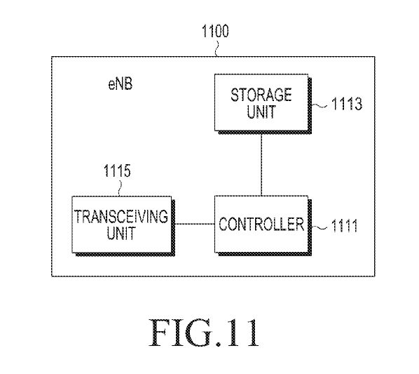

FIG. 11 is a diagram schematically illustrating an internal structure of an eNB that manages wireless LAN resources by utilizing a cellular base station in a WLAN system according to an embodiment of the present invention.

Referring to FIG. 11, an eNB 1100 includes a controller 1111, a storage 1113, and a transceiver 1115.

The controller 1111 controls the general operation of the eNB 1100. The controller 1111 controls the general operation of the eNB 1100 in association with operating a transmission opportunity period, with assistance from a cellular base station, according to an embodiment of the present invention, and operating a transmission opportunity period in an environment where a legacy device and a new device coexist, with assistance from a cellular base station, according to an embodiment of the present invention.

The transceiver 1115 transmits and receives various signals and various messages to/from an STA, an AP, and the like under the control of the controller 1111. Here, the various signals and various messages that the transceiver 1115 transmits and receives are the same as those of FIGS. 2 to 8, which have been described, and thus a detailed description thereof will be omitted.

The storage 1113 stores programs and various data required for the operation of the eNB 1100, particularly, information related to operating a transmission opportunity period with assistance from a cellular base station according to an embodiment of the present invention or operating a transmission opportunity period in an environment where a legacy device and a new device coexist, with assistance from a cellular base station according to an embodiment of the present invention. Also, the storage 1113 stores various signals and various messages that the transceiver 1115 receives from the STA, the AP, and the like.

Although FIG. 11 illustrates that the eNB 1100 is configured as separate units, namely the transceiver 1115, the controller 1111, and the storage 1113, it is also feasible that the eNB 1100 is configured in a manner in which at least two of the transceiver 1115, the controller 1111, and the storage 1113 are integrated as a single unit.

Particular aspects of the present invention may be implemented as a computer-readable code in a computer-readable recording medium. The computer-readable recording medium is a predetermined data storage device which can store data which can be read by a computer system. Examples of the computer readable recording medium may include a read-only memory (ROM), a random access memory (RAM), a CD-ROM, a magnetic tape, a floppy disk, an optical data storage device, and a carrier wave (such as data transmission through the Internet). The computer-readable recording medium may be distributed through computer systems connected to the network, and accordingly the computer-readable code is stored and executed in a distributed manner. Further, functional programs, codes and code segments for achieving the present invention may be easily interpreted by programmers skilled in the art which the present invention pertains to.

It will be understood that a method and apparatus according to an embodiment of the present invention may be implemented in the form of hardware, software, or a combination of hardware and software. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It can be also appreciated that the memory included in the mobile terminal is one example of machine-readable devices suitable for storing a program including instructions that are executed by a processor device to thereby implement embodiments of the present invention.

Accordingly, the present invention includes a program for a code implementing the apparatus and method described in the appended claims of the specification and a machine (a computer or the like)-readable storage medium for storing the program. Further, the program may be electronically transferred by a predetermined medium such as a communication signal transferred through a wired or wireless connection, and the present invention appropriately includes equivalents of the program.

Further, an apparatus according to an embodiment of the present invention may receive the program from a program providing device that is wiredly or wirelessly connected thereto, and may store the program. The program providing device may include a program including instructions through which a program processing device performs a preset content protecting method, a memory for storing information and the like required for the content protecting method, a communication unit for performing wired or wireless communication with the program processing device, and a controller for transmitting the corresponding program to a transceiver at the request of the program processing device or automatically.

Although the embodiment has been described in the detailed description of the present invention, the present invention may be modified in various forms without departing from the scope of the present invention. Therefore, the scope of the present invention should not be defined as being limited to the embodiments, but should be defined by the appended claims and equivalents thereof.

1-28. (canceled)

29. A communication method of a station in a wireless communication system, the communication method comprising:
receiving, from a base station serving the station in a cellular network, information indicating a first transmission period of an access point serving the station in a wireless network;
setting a first channel period, for communicating with the access point, based on the first transmission period;
receiving, from the access point, information indicating a second transmission period determined by the access point; and
updating the first channel period to a second channel period based on the second transmission period.

30. The communication method of claim 29, wherein:
the information indicating the first transmission period is included in a ready to send (RTC) frame, and
the information indicating the second transmission period is included in a clear to send (CTS) frame.

31. The communication method of claim 29, wherein the second transmission period is shorter than the first transmission period.

32. The communication method of claim 29, the communication method further comprising:
after updating the first channel period to second channel period:
receiving, from the access point, information indicating a third transmission period; and
re-updating the second channel period to the third transmission period,
wherein the third transmission period is set within a time obtained by subtracting the second transmission period from the first transmission period.

33. The communication method of claim 29, the communication method further comprising monitoring a channel between the station and the access point during one of the first transmission period, the second transmission period, or a third transmission period.

34. A communication method of an access point in a wireless communication system, the communication method comprising:
determining, by the access point serving a station in a cellular network, information indicating a second transmission period for the access point, the information indicating the second transmission period being provided to the station by a base station serving the station in a wireless network;
receiving, from the base station, information indicating a first transmission period of the access point;
transmitting, to the station, the information indicating the second transmission period, the second transmission period shorter than the first transmission period; and
communicating with the station during a channel period, the channel period being set based on the information indicating the second transmission period by the station.

35. The communication method of claim 34, wherein:
the information indicating the first transmission period is included in a ready to send (RTC) frame, and
the information indicating the second transmission period is included in a clear to send (CTS) frame.

36. The communication method of claim 34, wherein the determining the information indicating the second transmission period comprises:
transmitting, to the base station, information indicating the second transmission period; and
negotiating, with the base station, to determine the information indicating the second transmission period.

37. The communication method of claim 34, the communication method further comprising:
after the channel period is set by the station:
transmitting, to the station, information indicating a third transmission period; and
updating the channel period based on the information indicating the third transmission period.

38. The method of claim 37, wherein the third transmission period is set within a time obtained by subtracting the second transmission period from the first transmission period.

39. A station in a wireless communication system, the station comprising:
a transceiver configured to communicate with an access point serving the station; and
a controller configured to:
receive, from a base station serving the station in a cellular network, information indicating a first transmission period of an access point serving the station in a wireless network,
set a first channel period, for communicating with the access point, based on the first transmission period,
receive, from the access point, information indicating a second transmission period determined the access point, and
update the first channel period to a second channel period based on the second transmission period.

40. The station of claim 39, wherein:
the information indicating the first transmission period is included in a ready to send (RTC) frame, and
the information indicating the second transmission period is included in a clear to send (CTS) frame.

41. The station of claim 39, wherein the second transmission period is shorter than the first transmission period.

42. The station of claim 39, wherein the controller further configured to:
after updating the first channel period to second channel period:
receive, from the access point, information indicating a third transmission period, and
re-update the second channel period to the third transmission period,
wherein the third transmission period is set within a time obtained by subtracting the second transmission period from the first transmission period.

43. The station of claim 39, wherein the controller is further configured to monitor a channel between the station and the access point during one of the first transmission period, the second transmission period, or a third transmission period.

44. An access point in a wireless communication system, the access point comprising:
a transceiver configured to communicate with a station; and
a controller configured to:
determine information indicating a second transmission period for the access point, the information indicating the second transmission period being provided to the station by a base station serving the station in a wireless network,
receive, from the base station, information indicating a first transmission period of the access point,
transmit, to the station, the information indicating the second transmission period, the second transmission period shorter than the first transmission period, and
communicate with the station during a channel period, the channel period being set based on the information indicating the second transmission period by the station.

45. The access point of claim 44, wherein:
the information indicating the first transmission period is included in a ready to send (RTC) frame, and
the information indicating the second transmission period is included in a clear to send (CTS) frame.

46. The access point of claim 44, wherein the controller is further configured to:
transmit, to the base station, information indicating the second transmission period, and
negotiate, with the base station, to determine the information indicating the second transmission period.

47. The access point of claim 44, wherein the controller further is configured to:
after the channel period is set by the station,
transmit, to the station, information indicating a third transmission period, and
update the channel period based on the information indicating the third transmission period.

48. The access point of claim 45, wherein a third transmission period is set within a time obtained by subtracting the second transmission period from the first transmission period.
